(19) United States
(12) Patent Application Publication
(10) Pub. No.: US 2015/0306793 A1
(43) Pub. Date: Oct. 29, 2015

(54) METHOD FOR MANUFACTURING COMPOUND DIAPHRAGM

(71) Applicant: Bingke Zhu, Shenzhen (CN)

(72) Inventor: Bingke Zhu, Shenzhen (CN)

(73) Assignee: AAC MICROTECH (CHANGZHOU) CO.,LTD., Changzhou city (CN)

(21) Appl. No.: 14/522,650

(22) Filed: Oct. 24, 2014

(30) Foreign Application Priority Data
Apr. 25, 2014 (CN) 201410174169.9

(51) Int. Cl. B29C 39/00; B29C 39/02

(52) U.S. Cl. CPC B29C 39/003; B29C 39/026; B29L 2031/38

(57) ABSTRACT

The present disclosure provides a method for manufacturing a compound diaphragm. The method includes the following steps: Step 1: providing a powdered graphene; Step 2: providing a macromolecular raw material; Step 3: mixing the graphene and the macromolecular raw material to obtain a mixture; Step 4: heating the mixture to obtain a mixed paste; and Step 5: pressing the mixed paste into the compound diaphragm through a tape casting process. The method for manufacturing a compound diaphragm is simple, has a low production cost, and can provide a compound diaphragm with high strength and superior performances.

### FIELD OF THE INVENTION

The present disclosure relates to a method for manufacturing a compound diaphragm.

### DESCRIPTION OF RELATED ART

As being propelled by the increasingly heightened requirements on mobile phones in the market, the mobile phones trends to be designed with low profile and better sound quality. For meeting this trend or requirement, acoustic components used in the mobile phones should also be designed to have small sizes and high sound quality.

The diaphragm is known as a core element of an acoustic component such as a speaker etc, so the demand for acoustic performances of the diaphragms becomes also higher correspondingly.

The diaphragms in the related art are formed of a single cloth diaphragm or other materials, which can be hot-press molded, through a pressing process. However, the diaphragms of this structure tend to produce the split vibration (unbalanced vibration) due to the insufficient stiffness of the diaphragms, and this leads to distortion and adversely affects the hearing experience.

Additionally, in practical applications, in order to enhance the strength of the diaphragms without affecting the sound quality, a common practice in the related art is to increase the thickness of partial areas of the diaphragms. However, the diaphragms formed of a single material have the same thickness throughout the diaphragms once being produced, so they cannot satisfy the aforesaid requirements.

Accordingly, there maintains a requirement in the art to provide a novel compound diaphragm that can overcome the aforesaid shortcomings.

### BRIEF DESCRIPTION OF THE DRAWINGS

FIG. 1 is a flowchart of a process for manufacturing a compound diaphragm of the present disclosure.

### DETAILED DESCRIPTION OF THE INVENTION

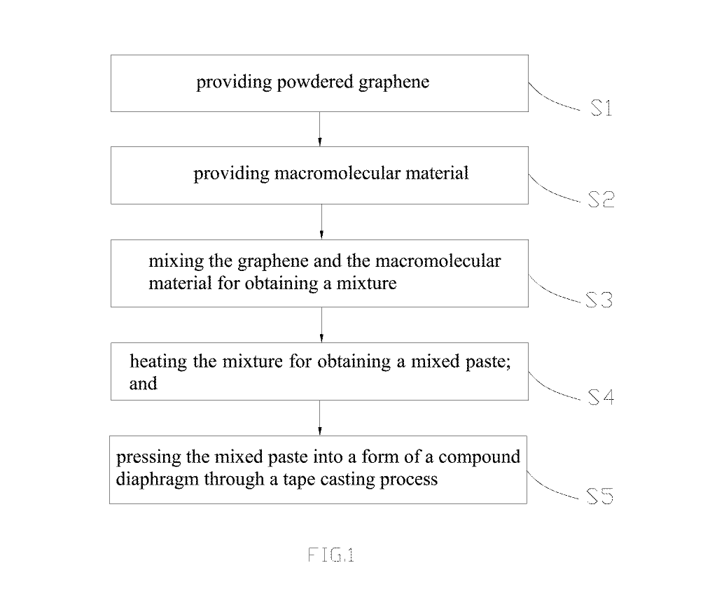

Hereinbelow, a compound diaphragm of the present disclosure will be described in detail. Referring to FIG. 1, a method for manufacturing a compound diaphragm comprises the following steps:

Step 1: providing powdered graphene;

Step 2: providing macromolecular material;

Step 3: mixing the graphene and the macromolecular material to obtain a mixture;

Step 4: heating the mixture to obtain a mixed paste; and

Step 5: pressing the mixed paste into a form of compound diaphragm through a tape casting process.

Optionally, in this embodiment, the macromolecular material provided in the step 2 is a solid material in a granulate or powdered form. The graphene and the macromolecular material are fully mixed and stirred to obtain a solid mixture. Then, the mixture is heated to a molten state to obtain a mixed paste, and preferably, binder, dispersant and solvent or the like are added into the mixed paste and then fully stirred and mixed to form a mixed slurry.

Afterwards, the mixed slurry is tape cast after being de-foamed. Further, the compound diaphragm that is tape cast is dried.

The macromolecular material may be any of polyetheretherketone (PEEK), polyethylene naphthalate (PEN), polyethylene terephthalate (PET), polyphenylene sulfide (PPS) and polyarylate (PAR).

Most preferably, PEEK is used because it features a high elasticity modulus and high abrasive resistance. Use of PEEK can enhance the strength and stiffness and improve the acoustic performances of the compound diaphragm.

The method for manufacturing a compound diaphragm of the present disclosure is simple, has a low production cost, and can provide a compound diaphragm with high strength and superior performances, and as compared to the conventional compound diaphragms, the compound diaphragm prepared by this method is more robust, stable and reliable. The compound diaphragm prepared by this method can be used in electroacoustic devices such as loud speakers and sound receivers.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A method for manufacturing a compound diaphragm, comprising the following steps:
Step 1: providing powdered graphene;
Step 2: providing macromolecular material;
Step 3: mixing the graphene and the macromolecular material for obtaining a mixture;
Step 4: heating the mixture for obtaining a mixed paste; and
Step 5: pressing the mixed paste into a form of a compound diaphragm through a tape casting process.

2. The method for manufacturing a compound diaphragm of claim 1, wherein the macromolecular material is of granulate structure.

3. The method for manufacturing a compound diaphragm of claim 1, wherein the step 4 further comprises the step of adding binder, dispersant and solvent into the mixed paste and fully mixing them for forming mixed slurry.

4. The method for manufacturing a compound diaphragm of claim 3, wherein the step 5 comprises the step of tape casting the mixed slurry after de-foaming the mixed slurry.

5. The method for manufacturing a compound diaphragm of claim 4, further comprising drying the compound diaphragm that is tape casted.

6. The method for manufacturing a compound diaphragm of claim 1, wherein the macromolecular material is any of polyetheretherketone (PEEK), polyethylene naphthalate (PEN), polyethylene terephthalate (PET), polyphenylene sulfide (PPS) and polyarylate (PAR).
